(19) United States
(12) Patent Application Publication
(10) Pub. No.: US 2010/0241584 A1
(43) Pub. Date: Sep. 23, 2010

(54) FLEXIBLE DESIGN PENSION ACCOUNT

(75) Inventors: James P. Kirkman, Acton, MA (US); William F. Borowski, Millbury, MA (US); Kazi M. Ariff, Quincy, MA (US); Carol A. Smith, Edgartown, MA (US); Judith M. Anderson, East Walpole, MA (US); Steven K. Hayes, Bemus Point, NY (US); Thomas D. Kelley, Hingham, MA (US); Neal G. Wolfson, Lexington, MA (US); Susan S. Thomas, Gastonia, NC (US); Russell W. Tipper, Boston, MA (US); Jeffrey P. Judd, Boston, MA (US); William J. Aheron, Charlotte, NC (US); Yicong Li, Lexington, MA (US); Shane A. Johnson, Charlotte, NC (US); Sean M. O'Connor, Scituate, MA (US); Jeffrey H. Bierer, Charlotte, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/407,874

(22) Filed: Mar. 20, 2009

(51) Int. Cl. G06Q 40/00

(52) U.S. Cl. 705/36 R

(57) ABSTRACT

Apparatus and methods for configuring a flexible pension account are provided. A flexible pension account may be offered as a product of a financial institution. Terms governing contribution of funds to the account, distribution of funds from the account, modifications to the account and management of the account may be chosen to create an account customized toward individual customer needs. The flexibility within the account design allows for unequal contributions from a variety of contributors as well as unequal distributions to a variety of beneficiaries. The flexible design may be combined, in certain embodiments, with tax-deferred growth and a minimum income guarantee. Account management and modification may be in the hands of an account administrator.

### FIELD OF TECHNOLOGY

Aspects of the disclosure relate to retirement savings. In particular, the disclosure relates to configuring a pension account incorporating flexibility in designing and modifying the terms of the account.

### BACKGROUND

A pension is an arrangement to provide an individual with income where the distribution is contingent on occurrence of a prearranged condition. In most cases, the distribution is contingent on the individual reaching a specified age or retiring from employment.

Some pensions are structured around defined contributions. The funds available for distribution from such pensions vary with investment success. Other pensions are structured around defined benefits and offer a guaranteed distribution. A pension may also be structured with a combination of defined contribution and defined benefit elements. Taxes on the growth of pension funds are typically deferred until distribution. A pension may be provided by the government or by an employer, or may be arranged privately.

One form of a privately established pension is an account offered by a financial institution. The account requires contributions to fund the pension and sets up terms governing distributions. If a pension account is a tool to protect against a possible future need, the terms of the account represent a best guess as to what that need will turn out to be.

Conventional pension accounts are often limited in the range of needs they address, and in the ability to modify the terms of the account in the face of changed circumstances.

Typically, a pension account is created for the benefit of a single individual, self-funded or funded by an organization. This structure excludes a variety of needs which could be addressed by a more flexible system. A pension account is of limited value if it imposes restrictions on designating the contributors or the uses for the funds.

Conventional pension accounts may also be limited in the flexibility to redirect the funds toward unanticipated needs. A pension account of necessity involves long range planning and it is impossible to precisely predict the best use of the funds. A pension account is also limited if the terms of the distribution cannot be changed to address changed circumstances.

It would be desirable therefore to configure a pension account combining tax-deferred growth with flexibility in designing and modifying the terms of the account.

### SUMMARY OF THE INVENTION

It is an object of this invention to provide apparatus and methods for configuring a pension account combining tax-deferred growth with flexibility in designing and modifying the terms of the account. Apparatus and methods for configuring such a flexible pension account are therefore provided.

The flexible pension account may be offered by a financial institution, enabling a customer to create financial security for retirement. Flexible terms may allow the customer to develop a pension customized to fit individual needs, or may allow a group to develop a single pension structure that benefits all participants.

The flexible pension account may offer flexibility in the designation of the contributors funding the account and in the specification of the contribution amounts and schedule of contributions.

The flexible pension account may also offer flexibility in the designation of the beneficiaries and in the specification of the distribution amounts and schedule. The account may permit specification of a remainder beneficiary.

The flexible pension account may also offer flexibility regarding modification of the account terms, as authorized by the original account agreement.

The flexible pension account may be managed by one or more account administrators. The account administrator may carry out functions associated with a trustee, including managing investments and overseeing any changes to the account terms.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention; and

FIG. 2 is a flow diagram that shows a process in accordance with the principles of the invention.

### DETAILED DESCRIPTION OF THE INVENTION

Apparatus and methods for configuring a pension account combining tax-deferred growth with flexibility in designing and modifying the terms of the account are provided.

In certain embodiments of the invention, the pension account may be adapted to include taxable and tax-deferred balances. While such taxable and tax-deferred balances may form a single account, the separate balances—i.e., tax-deferred and non-tax-deferred—may be accounted for separately within the account. The possibility of maintaining taxable balances within the pension account according to the invention could give users certain advantages. For example, one advantage of such an account would be the ability to contribute funds over and above any tax-deferred limits.

A pension account is a privately established pension marketed as a product of a financial institution. The account is funded by contributions. The account functions as a savings tool leveraging tax-deferred growth to accrue funds designated for a future need. Upon occurrence of a predetermined condition, the funds may be distributed as income to the beneficiary of the account.

Marketing a pension account as a financial product enables the average customer to create a customized pension without starting from scratch. The product may be compared to a template with terms that may be customized based on individual customer needs. By incorporating unprecedented flexibility into the template, the pension account may address a wide variety of needs and circumstances.

In one embodiment of the invention, a flexible pension account (FPA) may incorporate flexibility in the number of contributors to the account. For example, a group of contributors may choose to join together and pool assets to create a pension account. The group may modify the contribution pattern to suit its needs. For example, the contributions of the individual members may be equal or unequal and may be made on the same schedule or on a different schedule for each member of the group. Contributions may be automatically debited from a separate account owned by a contributor.

The FPA may also incorporate flexibility in the number of beneficiaries to the account. The terms of the account may be modified to allow for different patterns of distributions. Beneficiaries may receive equal or unequal distributions. Distributions may be made to all the beneficiaries on the same schedule or beneficiaries may receive distributions at different intervals.

The FPA may allow for the specification of a remainder benefit. Any funds remaining in the account after the account beneficiary dies may be held for the remainder beneficiary instead of passing through the account beneficiary's estate. The remainder beneficiary may be an individual or a group. A group of beneficiaries may receive equal or unequal distributions depending on the terms of the account.

The FPA may also incorporate flexibility in the terms governing of account administration. Examples of terms that may be customized include the investment choices for the account, the conditions which trigger distribution, the rules governing modification, and any other suitable term. The terms may also specify a defined usage for the distribution income. For example, the income stream may be dedicated to health care expenses for the beneficiaries.

The FPA may also incorporate flexibility regarding modification of account terms. The original terms of the account may authorize modification of any term in the account. The procedure for modification may also be laid out in the original account terms. The ability to modify terms gives the owners of the flexible pension account the peace of mind that the funds may be redirected if circumstances change.

The template for the FPA may also incorporate one or more fixed terms. Examples of fixed terms include tax deferral, a minimum income guarantee, account management via the Internet, administration by an account administrator, the ability to maintain tax-deferred and non-tax-deferred funds in the same account, and any other appropriate term.

The FPA may be administered by one or more account administrators. An account administrator may or may not have responsibilities such as those associated with a trustee. The account administrator may oversee any element of account activity including contributions of funds, investment decisions, monitoring growth of the funds in the account, distributions from the account and any modification to any terms of the account. Final decisions regarding any modification to the terms of the account or any other decision related to the account may rest with the account administrator.

The FPA may also incorporate a minimum income guarantee. The minimum income guarantee may ensure a continued minimum distribution from the account for the life of the account beneficiary, irrespective of the funding in the account. The guaranteed distribution may be calculated as a percentage of the account assets.

The FPA may be accessible via the Internet. Information regarding the account may be made accessible to the contributors and the beneficiaries. Account information may relate to the structure of the FPA, the terms of the FPA, the financial status of the FPA or any other relevant account information. An account administrator may take action related to the account via Internet access. Actions may include monitoring account performance, controlling investments, making modifications to the terms of the account and any other appropriate action.

The customized elements of flexible account design and the ability to modify the terms of the account, combined with tax-free growth and guaranteed benefits, make the FPA a powerful tool for both traditional and non-traditional retirement planning.

In one embodiment, the group of contributors may be unrelated individuals who want to take advantage of a plan that they can design according to their common need. The FPA allows the group to specify their level of contribution, dictate investment choices and define the terms of the distribution while still benefiting from the tax-free growth and guaranteed minimum distributions of a traditional pension account. As described above, in certain embodiments of the invention, the tax-free portion of the account may be combined with a taxable portion of the account.

The FPA is particularly useful in setting up intra-family financial arrangements. In one embodiment, the group of contributors may be family members with unequal earnings who want to provide for their retirement needs. The family members may contribute to the pension account unequally, but may decide that the distributions will be split equally. Alternatively, in this embodiment, the family members may decide that the distributions should go entirely to the low earner in the group, or to the low earner in a higher share. The flexibility of the FPA enables the family to structure a pension account tailored to its individual needs.

In another embodiment, the group of contributors may be children providing for their parents' retirement. The children may contribute to the fund equally or they may each contribute according to their financial ability. The funds may be turned toward another use depending on the circumstances. For example, the funds may be turned toward long-term care. If it becomes clear that the parents will not need the retirement income, the account may be modified, for instance, to create a new fund to be held for the contributors' children.

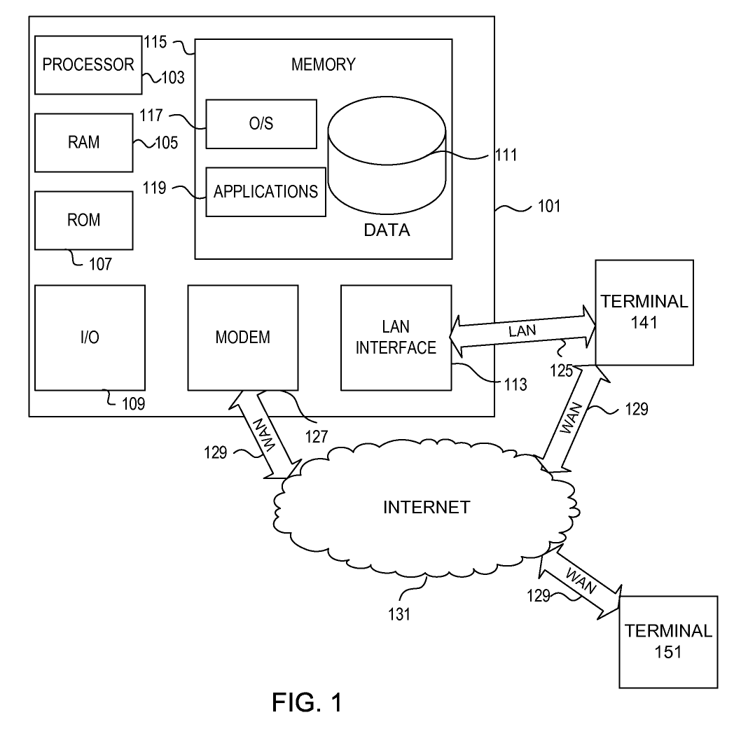

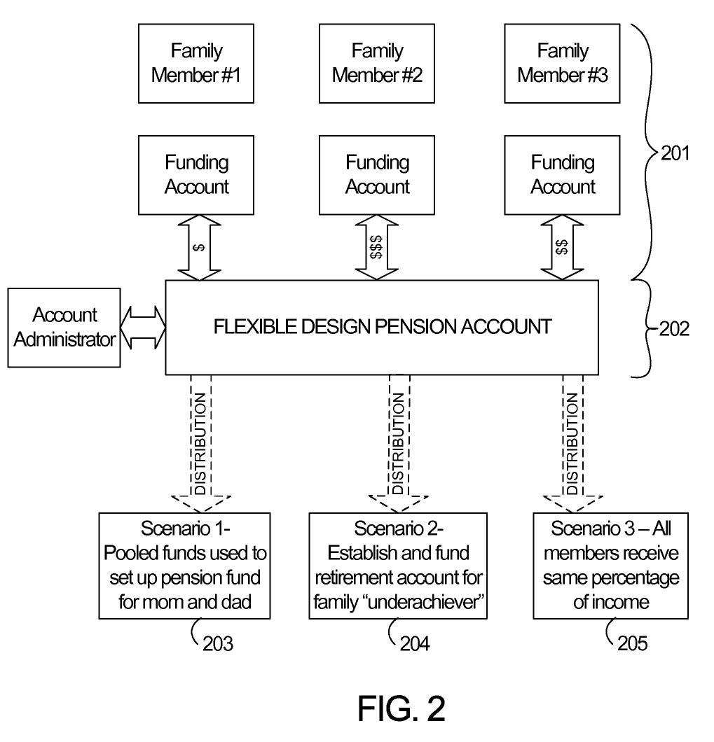

FIGS. 1 and 2 show illustrative embodiments and features of the invention.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for account information, information related to parties to the account, terms related to the account and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 2 is flow diagram showing illustrative process 200. For the sake of illustration, the process will be described as being performed by a system. The system may include one or more of the devices shown in FIG. 1 and/or any other suitable device.

Illustrative process 200 outlines the structure of an illustrative flexible pension account. The illustrative account is funded by contributions of varying amounts from three different family members. The process depicts three different alternatives for the account terms governing distributions.

At step 201, three different family members make contributions (shown by the symbol $ in FIG. 2) to fund the flexible pension account. The contributions can be unequal and in each case are debited directly from another account owned by the contributor. The flexible pension account enables any combination of family members to fund the account. The terms of the account may specify equal contributions or may establish contributions of varying amounts.

At step 202, the funds accumulate within the flexible pension account and are managed by the account administrator. Any changes to the terms of the account may also be under the control of the account administrator. The account preferably incorporates a means for defining a minimum guaranteed distribution for the beneficiary's lifetime. Such a minimum guaranteed distribution may be calculated based on a percentage of account assets.

The illustrative account next depicts three alternative scenarios for distribution. A flexible pension account may be adapted to cover many different scenarios; the three depicted in process 200 illustrate the way that flexibility in the distribution terms can enable the creation of a customized account tailored to the needs of an individual family. Process 200 may continue along one of these alternate paths at step 203, step 204 or step 205.

At step 203, distributions are made to the contributors' parents. At step 204, distributions are made to a family member who has not succeeded in saving for retirement. At step 205, distributions are made to all of the contributors in equal shares. In this third scenario, the flexible structure of the account allows the family members to care for each other by making contributions according to what they can afford but sharing equally in the pension distributions.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for configuring a master financial account providing comprehensive access to financial services are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for electronically configuring a flexible pension account, the method comprising:
receiving a selection of a term governing contribution of funds to a flexible pension account;
receiving a selection of a term governing distribution of funds from the flexible pension account;
receiving a selection of a term governing modification of the structure of the flexible pension account; and
configuring a flexible pension account, the structure corresponding, at least in part, to the selected term governing the contribution of funds, the selected term governing distribution of funds, and the selected term governing modification.

2. The method of claim 1 wherein the term governing contribution comprises at least one of a number of contributors, a schedule of contributions, and an amount of a contribution.

3. The method of claim 1 wherein the term governing distribution comprises at least one of a number of beneficiaries, a schedule of distributions, an amount of a distribution, specification of a remainder beneficiary, and a purpose for a distribution.

4. The method of claim 1 wherein modification is authorized for a term governing a contribution to the flexible pension account.

5. The method of claim 1 wherein modification is authorized for a term governing a distribution from the flexible pension account.

6. The method of claim 1, the method further comprising receiving a selection of an account administrator, the account administrator responsible for management of the funds in the flexible pension account.

7. The method of claim 6 wherein the account administrator is responsible for at least one of approving and executing a modification to the flexible pension account.

8. The method of claim 1, wherein the structure of the flexible pension account includes a minimum income guarantee, the amount of the minimum income guarantee dependent, at least in part, on the value of the account assets.

9. The method of claim 1, wherein the method further comprises providing access to the flexible pension account via an electronic information processing platform.

10. The method of claim 9 wherein the access is provided to at least one of a contributor to the account, a beneficiary of the account and an account administrator.

11. The method of claim 9 wherein the access further comprises using the electronic information processing platform to view a record related to the flexible pension account.

12. The method of claim 9 wherein the access further comprises using the electronic information processing platform to execute a management transaction related to the flexible pension account.

13. One or more computer-readable media storing computer-executable instructions, which, when executed by a processor on a computer system perform a method for configuring a flexible pension account, the method comprising:
receiving a selection of a term governing contribution of funds to a flexible pension account;
receiving a selection of a term governing distribution of funds from the flexible pension account;
receiving a selection of a term governing modification to the flexible pension account; and
configuring a flexible pension account, the structure corresponding to the selected term governing contribution of funds, the selected term governing distribution of funds, and the selected term governing modification.

14. The media of claim 13 wherein, in the method, the term governing contribution comprises at least one of a number of contributors, a schedule of contributions, and an amount of a contribution.

15. The media of claim 13 wherein, in the method, the term governing distribution comprises at least one of a number of beneficiaries, a schedule of distributions, an amount of a distribution, a specification of a remainder beneficiary, and a purpose for a distribution.

16. The media of claim 13 wherein, in the method the term governing modification comprises authorization for a modification regarding at least one of a term governing contribution, a term governing distribution and a term governing management of the flexible pension account.

17. The media of claim 13 wherein the method further comprises providing access to the flexible pension account via an electronic information processing platform.

18. The media of claim 17 wherein, in the method, access comprises using the electronic information platform to execute an account management transaction.

19. The media of claim 17 wherein, in the method, access comprises using the electronic information processing platform to view at least one of information related to an account record and information related to the account structure.

20. A system for electronically configuring a flexible pension account, the system comprising:
an input module configured to receive a selection of a plurality of terms governing the flexible pension account;
a processor module configured to create a flexible pension account, the terms of the account corresponding to the plurality of terms received; and
an output module configured to distribute account funds as determined by the terms of the flexible pension account.

21. The system of claim 20 wherein the input module is further configured to:
receive a contribution to the flexible pension account from a contributor identified in the account terms; and
store in machine readable memory a change in the financial status of the account corresponding to the contribution.

22. The system of claim 20 wherein the input module is further configured to:
receive an instruction from an account administrator related to management of the account funds; and
store in machine readable memory a change to the account structure, the change corresponding to the instruction of the account administrator.
